(19) United States
(12) Patent Application Publication
(10) Pub. No.: US 2011/0191439 A1
(43) Pub. Date: Aug. 4, 2011

(54) MEDIA CONTENT INGESTION

(75) Inventors: Alain Dazzi, San Jose, CA (US); Arun Krishnan, Cupertino, CA (US)

(73) Assignee: CLARENDON FOUNDATION, INC., Murray, UT (US)

(21) Appl. No.: 13/014,912

(22) Filed: Jan. 27, 2011

Related U.S. Application Data
(60) Provisional application No. 61/299,483, filed on Jan. 29, 2010.

(51) Int. Cl. G06F 15/16

(52) U.S. Cl. 709/217

(57) ABSTRACT

Ingesting media on a content distribution network includes obtaining media content in a media content ingestion system, storing the media content on a home storage volume of a data storage structure, and replicating the media content across multiple storage volumes on the data storage structure based on a set of data associated with the media content.

### CROSS-REFERENCE TO RELATED PATENT APPLICATIONS

The present application claims priority under 35 U.S.C. §119(e) to U.S. Provisional Patent Application Ser. No. 61/299,483, which was filed on Jan. 29, 2010.

### TECHNICAL FIELD

The present disclosure relates generally to computers and computer-related technology. More specifically, the present disclosure relates to the ingestion of media content into a system for storing and streaming the content.

### BACKGROUND

Computer and communication technologies continue to advance at a rapid pace. Indeed, computer and communication technologies are involved in many aspects of a person's day. Computers commonly used include everything from hand-held computing devices to large multi-processor computer systems.

Computers are used in almost all aspects of business, industry and academic endeavors. More and more homes are using computers as well. The pervasiveness of computers has been accelerated by the increased use of computer networks, including the Internet. These computers are often interconnected to form a computer network. One or more servers may provide data and services for other client computers on a network. The client computers are often referred to as clients. A computer network may include hundreds or even thousands of clients.

Content distribution networks (CDNs) provide media content (e.g. audio, video) streaming services to end users. Content providers desire their media content to be available to end users in a continuous playback environment and with minimal errors or buffer delays. However, traditional CDNs may only offer limited bandwidth.

### BRIEF DESCRIPTION OF THE DRAWINGS

FIG. 1 is a diagram showing an illustrative content distribution network, according to one example of principles described herein.

FIG. 2 is a block diagram showing an illustrative content distribution system, according to one example of principles described herein.

FIG. 3 is a block diagram showing an illustrative data storage structure, according to one example of principles described herein.

FIG. 4 is a diagram showing illustrative media storage components with a media ingestion system, according to one example of principles described herein.

FIG. 5 is a flowchart showing an illustrative method for ingesting media content onto a content distribution system, according to one example of principles described herein.

FIG. 6 is a flowchart showing an illustrative method for ingesting media content onto a content distribution system, according to one example of principles described herein.

FIG. 7 is an illustrative network incorporating an illustrative content ingestion system and method.

FIG. 8 is a block diagram illustrating a content ingestion workflow, according to one example of principles described herein.

### DETAILED DESCRIPTION

As described above, content distribution networks are commonly used to provide media streaming services to end users. A content distribution network is a group of computer systems working to cooperatively deliver content quickly and efficiently to end users over a network. End users are able to access a wide variety of content provided by various content producers. To compete for viewing time, content producers desire their media content to be available to end users in a continuous playback environment with minimal errors or buffer delays. Accomplishing this goal entails collaboration from a variety of networking equipment and storage systems. Such equipment and systems are often only capable of providing a limited bandwidth to end users. As a result, media content is often compressed using a variety of algorithms to reduce the amount of data required for streaming. However, media content can only be compressed to an extent. Thus, it is desirable to develop efficient structures and collaboration mechanisms which will provide media content to end users at a faster rate. Providing more media content data at a faster rate may allow smooth and error free media content streaming.

The present exemplary systems and methods relate to a system and method for ingesting media content into a content distribution system. According to one illustrative example, a media ingestion system may obtain media content from a content owner. The media content is then stored on a home volume on a data storage duster. The media content is then assigned an identifier which may be based on where the media content was stored on the data storage cluster. A set of data associated with the media content may determine how the media content is distributed across multiple volumes of the data cluster. For example, if a particular piece of media content is anticipated to be popular, it may immediately be distributed across locations which are closer to the end users. A media ingestion system or method embodying principles described herein will allow media content to be better organized and placed for faster streaming and wider availability to end users.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one example” or similar phrases in various places in the specification are not necessarily all referring to the same example.

Throughout this specification and in the appended claims, the term “content distribution network” refers to a network of computer systems and equipment set up for the purpose of delivering content to end users.

Throughout this specification and in the appended claims, the term “content distribution system” refers to a collection of computer-implemented functional components and hardware components used to accomplish the purposes of the content distribution network.

Throughout this specification and in the appended claims, the term “media ingestion system” refers to a system implemented by at least one processor which acquires media content from a content owner.

Throughout this specification and in the appended claims, the term “content owner” refers to a producer or holder of media content that desires to make that media content available through the content distribution network.

Throughout this specification and in the appended claims, the t′ “home storage volume” refers to a hardware memory volume on a data storage cluster in which a particular piece of media content is always available.

Throughout this specification and in the appended claims, the term “media content” may refer to an electronic file or group of electronic files which include various forms of media. According to one example, the media content may include, but is in no way limited to, video streams. The electronic files may be of a variety of format and operate with a variety of platforms.

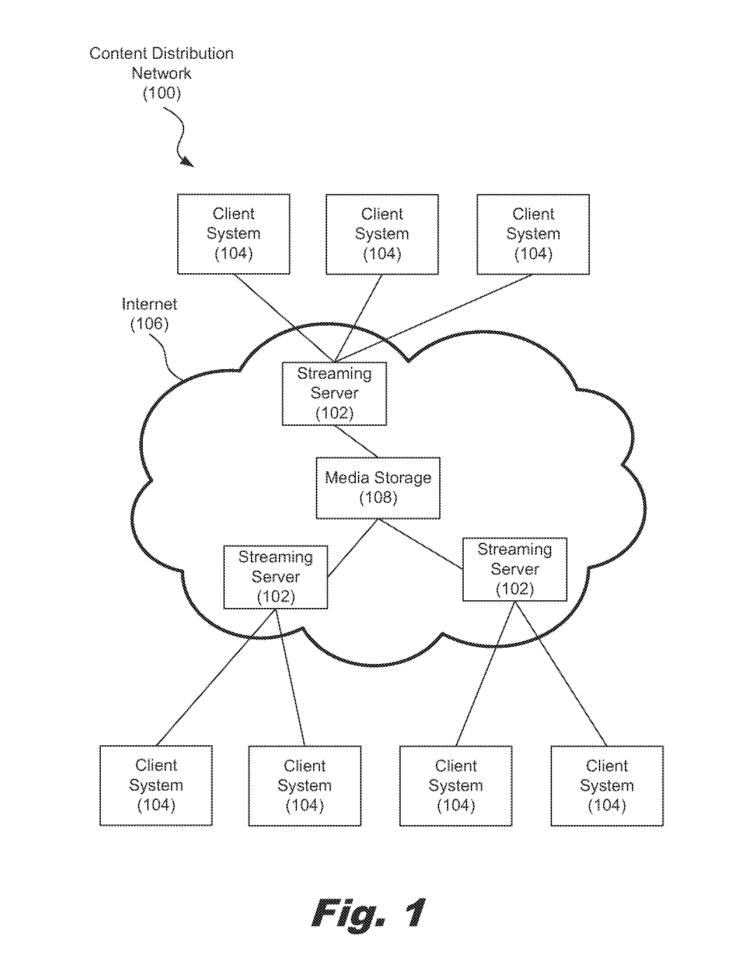

Referring now to the figures, FIG. 1 is a diagram showing an illustrative content distribution network. A traditional content distribution network (100) may include media storage (108) available on the internet (106). The media storage (108) may provide media content to a number of streaming servers (102). These streaming servers may in turn, stream the media content to a number of client systems (104) seeking access to the media content.

As mentioned above, it is desirable that streaming media content be delivered to client systems at a minimum bit rate to sustain quality and experience and with little error. The applicant has discovered a method to ingest media into a content distribution network which will strategically place and organize media content so as to increase the efficiency at which the media content is streamed to a client system (104). Increasing the efficiency maintains quality of service (QoS) for the streaming media content and thus increases the quality of the viewed media.

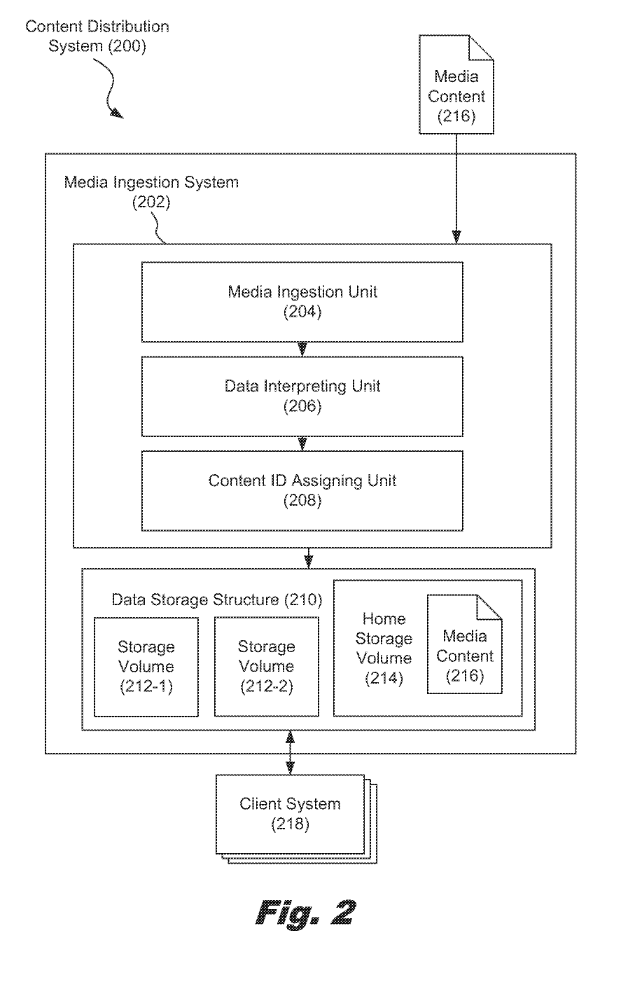

FIG. 2 is a block diagram showing an illustrative content distribution system (200) using a media ingestion system (202). According to one illustrative example, a content distribution system (200) may include a media ingestion system (202) having a media ingestion unit (204), a data interpreting unit (206), and a content ID assigning unit (208). The content distribution system (200) may also include a data storage cluster (210) having a number of storage volumes (212), as are readily known in the art. A client system (218) will be able to access the content distribution system (200) to obtain media content (216).

The media ingestion system (202) is, according to one example, responsible for acquiring and placing new or additional media content (216) from content owners. According to one example, the media ingestion system (202) can interpret a set of data associated with media content files that may help determine an appropriate placement on a data storage cluster (210). The media ingestion unit (204) is responsible for acquiring the media files and their associated set of data from content owners. The media ingestion unit (210) may be able to format the media content into a specific format as determined by the content distribution system (200).

The data interpreting unit (206) may be used to interpret data associated with ingested media content. This data may include content owner specific data. The data associated with ingested media content may also include data specific to the associated media content (216). This data may include, but is in no way limited to, anticipated popularity of the media content (216), statistical data regarding a past popularity of the media content, and/or geographic data indicating an anticipated popularity or demand for the media content in a particular geographic region. If the media content (216) is expected to be popular, it may be placed on a storage volume within a data storage cluster that is closer to the anticipated end user. Additionally or alternatively the media content (216) may be replicated across multiple volumes to increase access.

According to the present exemplary system, the content identifier assigning unit (208) may be used to assign a content identifier (ID) to each media content file that is acquired and stored on the content distribution system (200). The content ID may be assigned based on various properties of the media content file. These properties may include, but are not limited to, the location in the data storage cluster where the media content file will be stored, the provider of the media content file, or the media type.

As noted above, the distributed data storage cluster (210) may include a number of storage volumes (212). The data storage structure may be of a variety of data structure types currently known in the art. Each piece of media content (216) which is ingested into the content distribution system (200) may be assigned a home storage volume (214) somewhere within the data storage cluster (210). The home storage volume is a volume in which the media content is guaranteed to always be available. Furthermore, media content (216) may also be replicated to additional storage volumes (212) separate from the assigned home storage volume (214). This may be the case if the media content is expected to be in high demand by client systems (218).

According to this exemplary system and method, the assignation of a home storage volume (214) provides that the ingested media content (216) will always be available at any single point in time, regardless of the replication rules and actions implemented by the system.

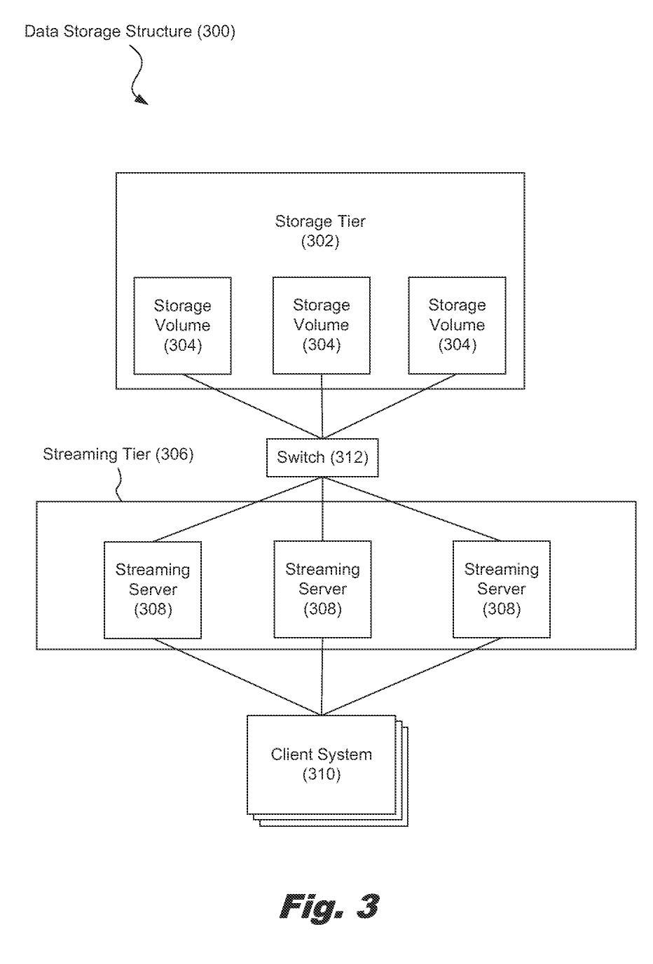

As mentioned above, the data storage cluster may include a variety of different data storage types. FIG. 3 is a block diagram showing an illustrative data storage structure. According to one illustrative example, a data storage structure (300) may include a storage tier (302) made of a number of storage volumes (304) and a streaming tier (306) made of a number of streaming servers (308). The storage tier (302) and the streaming tier (306) may be connected by a number of network switches (312).

The storage tier may include a number of storage volumes, in one example, the storage tier may include multiple tiers. The storage volumes (304) may be customized to hold different media content.

The streaming tier (306) may include a number of streaming servers (308). The streaming servers (308) may be located at the edge of the data storage structure (300) and be dispersed at different geographic locations, such that as a general rule, the streaming servers (308) are closer to individual client systems (310) then the storage volumes (304). The streaming servers (308) may be configured to temporarily store media content and stream the media content to a number of client systems (310). Additionally, the streaming servers (308) may store popular and/or high-demand media content on a more permanent basis. Additional details with regard to the architecture and operation of the data storage structure (300) shown in FIG. 3 can be found in U.S. patent application Ser. No. 13/014,881, entitled “Storing and Streaming Media Content,” the entire disclosure of which is incorporated herein by reference.

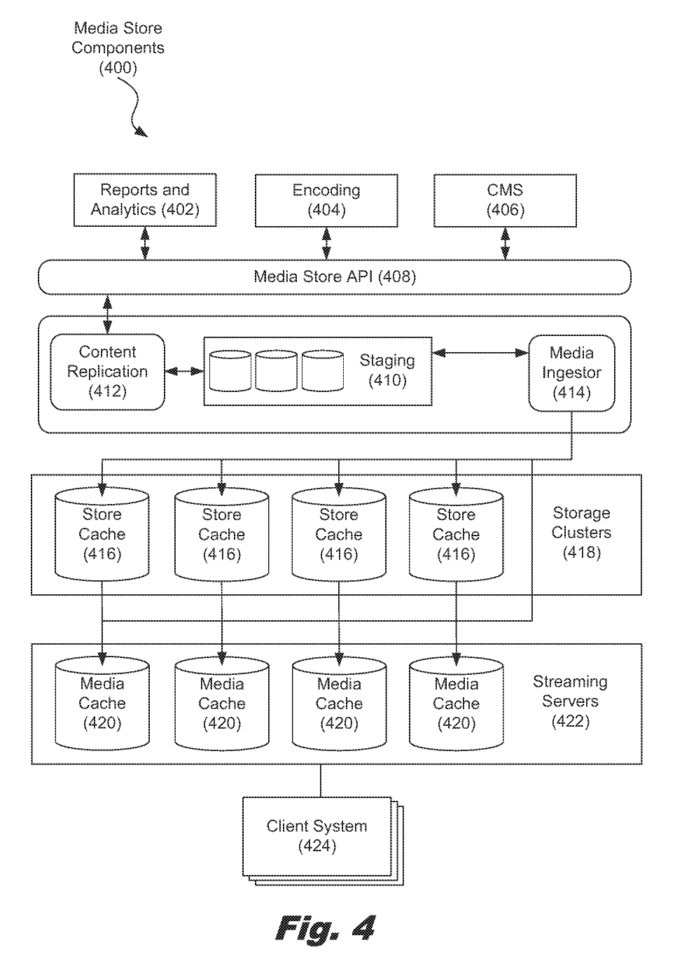

FIG. 4 is a diagram showing illustrative media storage components with a media ingestion system. As illustrated in FIG. 4, the client system (424) may directly access any number of streaming servers (422) containing a plurality of media caches local to the streaming servers (420). The streaming servers (422) may also be communicatively coupled to any number of storage clusters (418) containing media storage volumes (416) to efficiently store and provide access to media content that is not preferably on the streaming servers due to less demand, etc. As illustrated in the exemplary media storage system of FIG. 4, both the streaming servers (422) and the storage clusters (418) may be communicatively coupled to the media ingestor (414). According to this example, the media ingestor (414) may selectively house and/or replicate ingested media to the storage clusters (418) and the streaming servers (422) depending on the characteristics (such as demand, historical or anticipated viewing volume) of the ingested media. Further, as illustrated, the media ingestor (414) is communicatively coupled to the staging module (410), a content replication module (412) and a media store application programming interface (API) (408), access reports and analytics modules (402), encoding modules (404), and a Content Management System (CMS) (406).

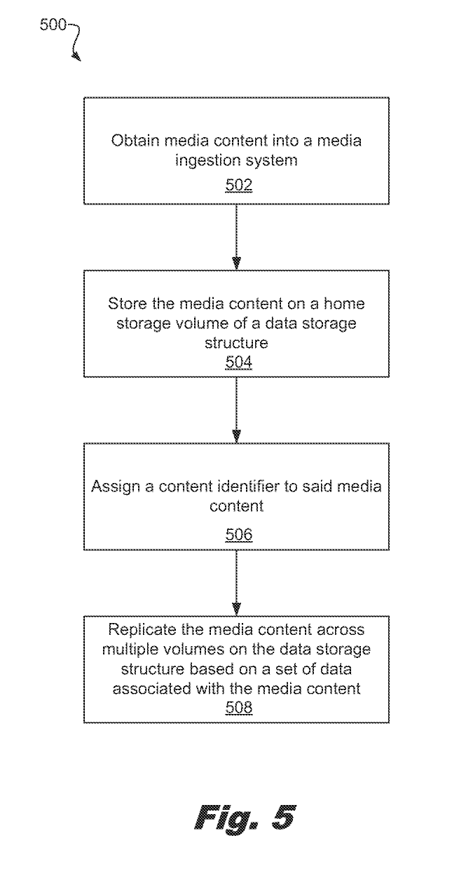

FIG. 5 is a flowchart showing an illustrative method (500) for ingesting media content onto a content distribution system. According to one illustrative example, media content is obtained (block 502) by a media ingestion system. The media content may be obtained by a content owner uploading the media content to the content distribution system using, for example, Hypertext Transfer Protocol (HTTP) or any other protocol that may suit a particular instance of the principles described herein. Thus, in some examples a content owner may upload the media content through an HTTP or File Transfer Protocol (FTP) client (e.g., a web browser) or using a UNIX command line.

The media content is stored (block 504) on a home storage volume of a data storage cluster. A content identifier is assigned (block 506) to the media content. The media content is then replicated (block 508) across multiple volumes of the data storage cluster based on a set of data which is associated with the media content. In this manner, the media content is readily available in an efficient manner, depending on its popularity and the degree of replication, while maintaining an assurance that the media content can be found on the home storage volume of a data storage structure.

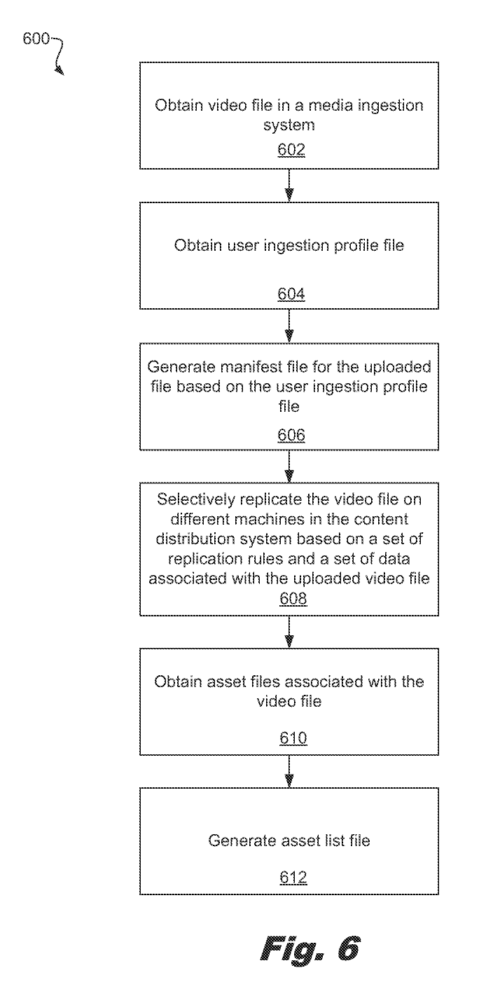

FIG. 6 is a flowchart showing an illustrative method (600) for ingesting a video onto a content distribution system. While the present example describes an ingestion process for a video, it should be understood that the principles described in this example may be applied to any type of media content file, including (but not limited to) audio files, image files, and text files. Ingestion begins when the media ingestion system Obtains (block 602) a video file uploaded by a content owner. In certain examples, the media ingestion system may encode the obtained video file into a format supported by the content distribution system. Alternatively, the obtained video file may be kept in its original file format.

The obtained video file is associated with the content owner through a user ingestion profile file for the content owner. The user profile file may be obtained (block 604) by the media ingestion system when the video file is uploaded. The user ingestion profile file may be provided by the content owner or generated automatically for the content owner, for example, the time the video file is uploaded. The ingestion profile file may specify a unique identifier assigned to that user and metadata to be associated with the video file. In some examples, the ingestion profile file may also include indications of a level of service purchased by that user, saved preferences for the user, and the like. The user ingestion profile file may be, for example, formatted as an extensible markup language (XML) or similar file.

From the user profile, a manifest file for the uploaded video file may be generated (block 606). The manifest file may also be in the form of an XML or similar format, and specify data for use in completing the ingestion of the uploaded video file into the content distribution system. For illustrative purposes, an example of one such manifest file is as follows:

```
<?xml version=“1.0” ?>
<ingest>
    <folder path=“2010_08_16”>
        <metadata>
        <title>2010_08_16 Folder</title>
        <keywords />
        <notes>Content uploaded on 2010_08_16</notes>
        </metadata>
        <videoTitle name=“WhenValueExceedsPricebyGrantCardone”>
            <!-- Video metadata -->
            <metadata>
                <title>WhenValueExceedsPricebyGrantCardone
                </title>
                <description />
                <goliveDate>2010_08_16</goliveDate>
                <expireDate>2010_08_16</expireDate>
                <thumbnailUrl />
                <category />
                <keywords />
                <duration />
                <notes />
            </metadata>
            <video
            src=“WhenValueExceedsPricebyGrantCardone.mp4”>
                <encoding bitrateMin=“450” h264=“True”
                priority=“3” />
            </video>
        </videoTitle>
    </folder>
</ingest>
```

As demonstrated above, the manifest file may provide ingestion parameters to the media ingestion system, including details for the creation of a folder for storing the uploaded video file and metadata for the video file itself.

With the creation of the manifest file, the uploaded video file may then be copied to a home storage volume of a data storage structure in the content distribution system. The video file will then be selectively replicated (block 608) on different machines of the content distribution system according to a configured set of replication rules and a set of data associated with the uploaded video file from the user. The replication rules may include a standard set of replication rules that are applicable to the content distribution system generally. Additionally or alternatively, the replication rules may be specific to the user uploading the video file. Such user-specific replication rules may supplement and/or supplant default general replication rules implemented by the media ingestion system.

The set of data associated with the media content from which replication decisions are made may include, for example, metadata for the uploaded video file, data uploaded separately by the user in connection with the uploaded video file, data in the ingestion profile file for the user, data stored by the media ingestion system for the user uploading the video file, and/or any other data that may be associated with the uploaded video file in the media ingestion system.

The replication rules determine how the uploaded video file will be selectively replicated onto the different machines. In certain examples, one or more replication rules may be geographic in nature. For example, the set of data uploaded with the video file may specify a geographic region with a high actual or anticipated demand for the video file or a geographic region for which the uploaded video file is targeted. Thus, the one or more replication rules may cause the video file to be replicated to edge streaming servers (volumes) that are geographically situated closest to a region for which the popularity of the video is higher than a defined threshold, or a region containing likely or targeted viewers.

In additional or alternative examples, one or more replication rules may specify that an uploaded video file will be replicated to streaming edge servers in proportion with a past, present, or anticipated future demand for that video file. The known or anticipated demand for an uploaded video file may be specified by the user uploading the video file at the time of ingestion, obtained through mathematic projections, obtained through third-party observations or projections, and/or the like.

In additional or alternative examples, one or more replication rules may cause an uploaded video file to be replicated according to the preferences of the user uploading the file or the content owner. For example, a user interface on a web site for ingesting the video file may allow the uploading user to specify a redundancy and/or geographic preferences for the uploaded video file.

In additional or alternative examples, one or more replication rules may cause the uploaded video file to be replicated in accordance with a membership or subscription level of the content owner, or in accordance with a level of streaming service purchased by the content owner. In this way, a content owner may purchase additional redundancy in the content distribution system to provide enhanced streaming service to viewers of a video which would not otherwise be replicated to the same extent across the content distribution system.

Asset files associated with the video file may also be obtained (block 610) by the media ingestion system from the content owner. These asset files may include one or more audio tracks (e.g., a separate audio file for which the video can be shown), one or more subtitle files, one or more thumbnail images, and the like. In certain examples, one or more of the asset files may be uploaded to the media ingestion system at the same time that the main video file is uploaded. Additionally or alternatively, one or more of the asset files may be uploaded at a later time. In certain examples, the media ingestion system may encode uploaded asset files to a format recognized or preferred by the content distribution system. Each asset file associated with a video file may be stored in the folder created for the video file at its home storage volume. Each asset file associated with a video file may be replicated at each storage volume where the video file is replicated. Thus, at each of these storage volumes a folder may exist which is duplicative of the folder created for the video file at its home storage volume.

An asset list file may be generated (block 612) for the video file at the home storage volume of the uploaded video file and replicated at each location that the uploaded video file is replicated. The asset list file may include a listing of each asset file associated with the uploaded video file. The asset file may be provided to a streaming client such that the streaming client may retrieve different asset files according to a particular streaming configuration.

The contents of the folder created for the uploaded video file at its home storage volume may dynamically change over time as the content owner adds, removes, and/or replaces asset files for the uploaded video file. Each time a change is made to the folder for the uploaded video file at its home storage volume, these changes are replicated at each storage volume in the content distribution system which replicates the uploaded video file. Furthermore, the asset list file for an uploaded video may be dynamically and automatically generated by the media ingestion system each time a change is made to the asset files associated with the uploaded video. As with other files in the folder for the uploaded video file at its home storage volume, whenever the asset file is changed, the change may propagate to each storage volume replicating the uploaded video.

In certain examples, a content owner of a video file may be content owner of multiple video files stored by and able to be streamed from the content distribution system. In these examples, the content owner of such files may be permitted to associate certain videos sequentially to create a playlist. Thus, for each video file stored by the content distribution system, one or more pointers to successive and/or preceding videos in one or more playlists may also be stored. In this way, a user streaming a video in a playlist from the content distribution system may be able to automatically or manually begin streaming a next video in the playlist when playback of a current video terminates.

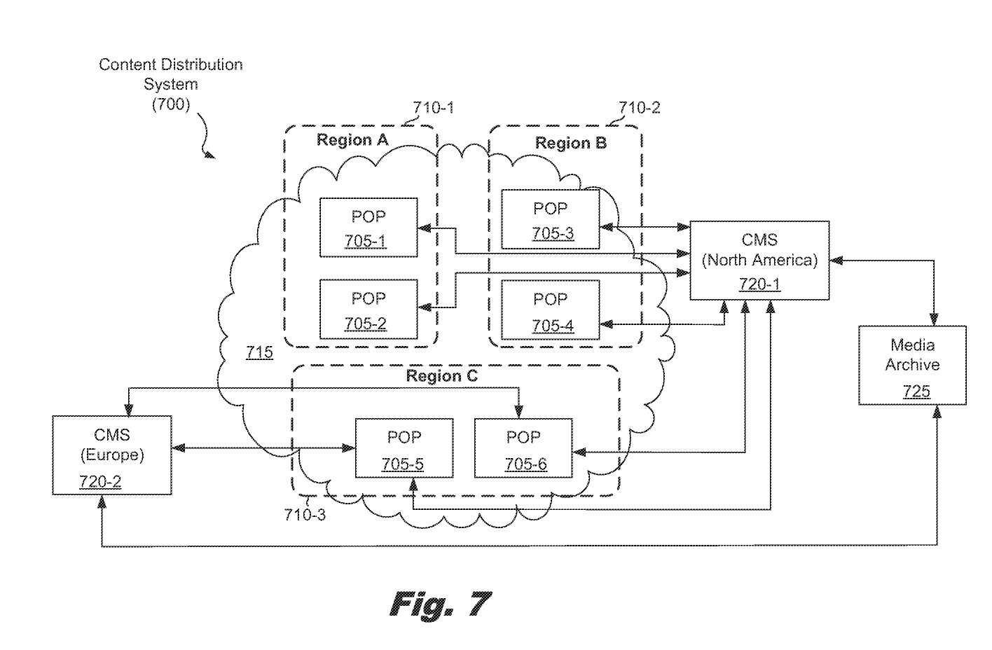

FIG. 7 is an exemplary content distribution system (700) incorporating the present exemplary content ingestion system and method. The exemplary system (700) includes a plurality of points of presence (POPs) (705-1 to 705-6) distributed across various geographical regions (710-1 to 710-3) and available to clients over a network (715) such as the Internet. Each POP (705-1 to 705-6) may include a storage volume that can be used to stream media content to a user over the network (715).

As described above, media content files streamed to clients may be ingested into a content distribution system using a Content Management System (CMS) (720-1, 720-2). In the present example, two CMS instances are implemented at different geographic regions. A main CMS (720-1) may interact with and manage file replication for each POP (705-1 to 705-6) in the entire system (700), while a secondary CMS (720-2) may interact with and manage only a subset of the POPs in a specific region (710-3). Each media content file stored at a POP (705-1 to 705-6) may also be stored in a media archive (725) for the system (700).

As described above, media content file ingested at a CMS instance (720-1, 720-2) is evaluated and a need for replication is determined and executed according to the replication rules. According to one example, specific Replication rules are customized for each content owner and saved in the CMS database. Rules support ingestion and replication of content on the basis of regions (710-1 to 710-3), POPs (705-1 to 705-6), clusters and servers.

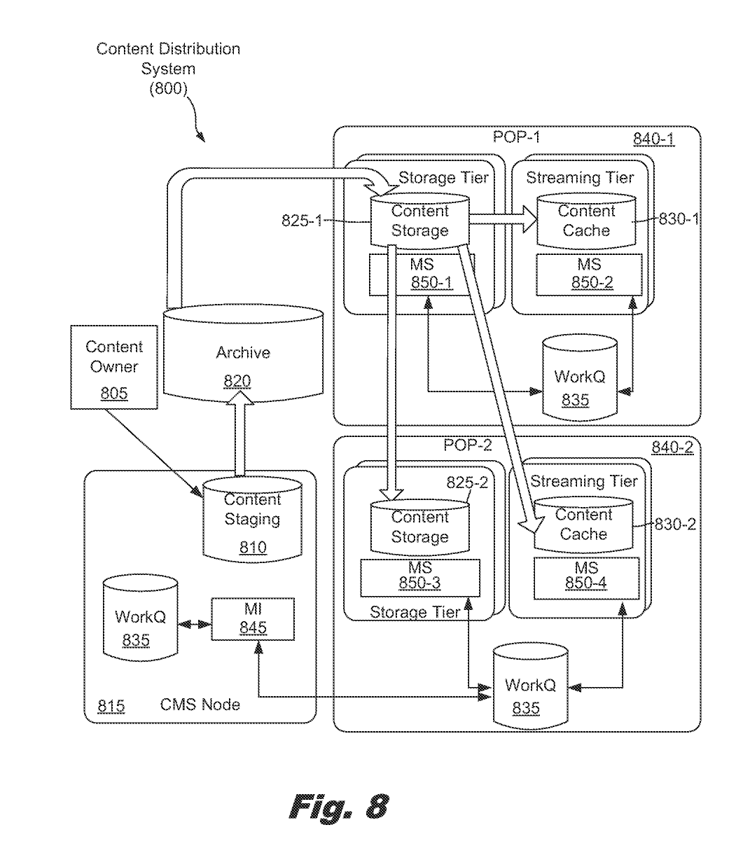

Turning now to FIG. 8, a content ingestion workflow is illustrated. As mentioned above, the media content uploaded from a content owner (805) may be first received into the staging area (810) of a CMS node (815). The content is then moved to different storage volumes (820, 825-1, 825-2, 830-1, 830-2) based on the replication rules.

As shown, components involved in the ingestion and replication of content are synchronized using a database table referred to as a WorkQ (835). The WorkQ (835) is shown separately in the CMS node (815), a first POP (840-1), and a second POP (840-2) for clarity, but it should be understood that the same WorkQ (835) may be used and available at each of these locations over a network connection. The WorkQ (835) may be used to coordinate the completion of tasks from a media ingestion (MI) process (845) of the CMS node (815) and media store (MS) processes (850-1 to 850-4) associated with the tiers of the different POPs (840-1, 840-2).

Tasks in the WorkQ move through different states. Modules responsible for various sub-tasks pick up tasks that are in an appropriate start state and then after processing them place them in a final end state. The system as a whole runs like a state machine that moves tasks through various states involved in content ingestion.

For example, the MI process (845) and the MS processes (850-1 to 850-4) may continuously monitor the WorkQ (835) for new tasks, perform tasks as they are detected in the WorkQ (835), and update a status of each task in the WorkQ (835) as it is completed. In this way the MI process (845) and the MS processes (850-1 to 850-4) may work together in an asynchronous fashion, thereby increasing productivity.

FIG. 8 illustrates the workflow associated with moving uploaded media content through an exemplary content distribution system (800) consistent with the principles described herein. For each media content file uploaded to the content staging area (810) of the CMS node (815), a new ingestion task is created in the WorkQ (835) for the MI process (845). If the uploaded media content file needs to be encoded to a format preferred or supported by the content distribution system (800), an encoding task may be placed in the WorkQ (835) prior to the ingestion task. Once an encoding subsystem (not shown) has encoded the media content file, the encoded task will be marked as completed in the WorkQ (835), and the ingestion task will be created in the WorkQ (835) for the MI process (845). The MI process (845) may copy the media content file to an archive storage volume (820), determine a home storage volume for the media content file, and enter a task into the WorkQ for the MS process associated with the home storage volume to cause the media content file to be copied to the home storage volume. Optionally, the MI process (845) may also cause the uploaded media content file to be encoded to a format preferred by the content distribution system.

In the present example, the home storage volume is a server for content storage (825-1) in the storage tier (825-1) of the first POP (840-1). Additionally, in the present example the replication rules of the content distribution system (800) require the uploaded media content file to be replicated to the content storage (825-1, 825-2) and content cache (830-1, 830-2) portions of each POP (840-1, 840-2). Thus, a replication task will be placed in the WorkQ (835) for the MS processes (850-2, 850-3, 850-4) implemented by the streaming tier of the first POP (840-1), the storage tier of the second POP (840-2), and the streaming tier of the second POP (840-2). Once the media content has been replicated at each location specified by the replication rules, replication will be complete.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A method for ingesting media on a content distribution network, the method comprising:
obtaining media content in a media content ingestion system;
storing said media content on a home storage volume of a data storage structure; and
replicating said media content across multiple storage volumes on said data storage structure based on a set of data associated with said media content.

2. The method of claim 1, in which said set of data comprises data indicating a popularity of said media content.

3. The method of claim 2, in which said set of data comprises statistical data indicating a past popularity of said media content.

4. The method of claim 2, in which said set of data comprises data indicating an anticipated popularity of said media content.

5. The method of claim 2, in which said replicating said media content across multiple storage volumes on said data structure based on said set of data associated with said media content comprises replicating said media content to a number of said volumes in proportion to a degree of said popularity of said media content.

6. The method of claim 1, in which said set of data comprises data indicating a geographical region.

7. The method of claim 6, in which said replicating said media content across multiple storage volumes on said data structure based on said set of data associated with said media content comprises replicating said media content to at least one said volume geographically located in said geographical region.

8. The method of claim 1, in which said set of data comprises data indicating a replication preference of a content owner.

9. The method of claim 8, in which said replicating said media content across multiple storage volumes on said data structure based on said set of data associated with said media content comprises replicating said media content in accordance with said replication preference of said content owner.

10. The method of claim 1, in which said set of data comprises data indicating a level of streaming, service associated with a content owner.

11. The method of claim 10, in which said replicating said media content across multiple storage volumes on said data structure based on said set of data associated with said media content comprises replicating said media content in proportion to said level of streaming service associated with said content owner.

12. The method of claim 1, further comprising assigning a content identifier to said media content.

13. A media ingestion system comprising:
at least one processor communicatively coupled to at least one memory, said at least one processor being configured to execute code stored by said at least one memory to implement:
a media ingestion unit configured to acquire media content; and
a data interpreting unit configured to interpret al. set of data associated with said media content;
in which said system is configured to replicate said media content across multiple storage volumes in a content distribution system, the multiple storage volumes being selected based on said set of data associated with said media content.

14. The system of claim 13, in which said set of data comprises data indicating a popularity of said media content.

15. The system of claim 14, in which said replicating said media content across multiple storage volumes in said content distribution system based on said set of data associated with said media content comprises replicating said media content to a number of said volumes in proportion to a degree of said popularity of said media content.

16. The system of claim 13, in which said set of data comprises data indicating a regional popularity of said media content.

17. The system of claim 13, in which said set of data comprises data indicating a replication preference of a content owner.

18. The system of claim 13, in which said set of data comprises data indicating a level of streaming service associated with a content owner.

19. A computer program product, comprising:
a computer-readable hardware storage medium comprising stored computer-readable program code; said computer-readable program code comprising:
computer-readable program code configured to obtain media content from a content owner;
computer-readable program code configured to store said media content on a home storage volume of a data storage structure; and
computer-readable program code configured to replicate said media content across multiple storage volumes on said data storage structure based on a set of data associated with said media content.

20. The computer-program product of claim 19, wherein said set of data comprises at least one of:
data indicating a popularity of said media content, data indicating a geographic region, data indicating a preference of a content owner, and data indicating a level of streaming service associated with said content owner.
